(19) United States
(12) Patent Application Publication
(10) Pub. No.: US 2003/0104780 A1
(43) Pub. Date: Jun. 5, 2003

(54) Pole mounted bi-directional RF converter amplifier and system

(76) Inventor: Michael Francis Young, McLean, VA (US)

Correspondence Address: Michael Young c/o Young Design Inc, 8000 Lee Highway, Falls Church, VA, 22042, US

(21) Appl. No.: 10/337,333

(22) Filed: Jan. 7, 2003

Related U.S. Application Data
(63) Continuation of application No. 09/505,201, filed on Feb. 16, 2000.

(51) Int. Cl. H04B 3/36

(52) U.S. Cl. 455/7; 455/561

(57) ABSTRACT

A remote mounted RF (radio frequency) bi-directional converter/amplifier device that connects to a half-duplex radio transceiver that converts and amplifies the RF signals to and from that signal to a different radio band. The pole mounted converter senses when the transceiver connected to it goes into the transmit mode and automatically switches the device from converting the received signal to the RF band of the transceiver to converting the RF signal from the transceiver to a different frequency band and amplifying that transmit signal. Refer to FIG. 1. This invention is an improvement to and continuation of the amplifier system that is disclosed in Utility patent application Ser. No. 09/505,201 filed Feb. 16, 2000.

### BACKGROUND OF THE CURRENT INVENTION

The 2.4 GHz license-free radio band is widely used for Spread Spectrum Wireless Local Area Network (WLAN) applications. The most commonly used technology in this is bands are devices designed to comply with the IEEE 801.11 and 802.11b standards. This standard specifies half-duplex operation in a Time Division Duplex (TDD) mode. In TDD, each radio can receive and transmit, but not at the same time. Two-way duplex communication takes place by sharing the airwaves based on time slots. One unit transmits and the other listens. Once the first unit goes off the air and switches to receive mode, the other unit is free to use the airwaves and send its data. If for some reason, two devices in communication with each other transmit at the same time, the data packets will be lost and will need to be retransmitted.

Most of these WLAN devices use the 802.11b standard. This standard defines fourteen Direct Sequence Spread Spectrum (DSSS) channels separated by five MHz, (i.e., 2412 MHz, 2517 MHz, 2422 MHz, etc.). Only the first eleven of which can be used in the United States. Each channel occupies about 22 MHz of bandwidth. Therefore, at any one location (e.g., office, rooftop, or radio tower) a maximum of three 801.11b DSS radio channels can be used—typically channels 1, 6 and 11. If the channels are too close to each other are used (e.g., channels 5 and 7) the sideband noise from the radiated spectrum from one transmitter will interfere with the reception of the remote client signals on other co-located radios. Thus, in most installations, no more then three 802.11b radio channels are used at any one location.

There are many manufacturers that make WLAN device for this band and many millions of these devices have been sold worldwide. This has reduced the cost of these high-performance radio devices serving to expand their proliferation.

These WLAN devices were originally designed for indoor use to provide wireless connectivity to PCs and other devices. However, by using external outdoor antennas and amplifiers (like that disclose in Utility patent application Ser. No. 09/505,201) with these devices enable long-range outdoor applications. These have proliferated in recent years crowding the 2.4 GHz license-free radio band.

Also operating on this band are microwave ovens, cordless telephones, low-power video surveillance cameras, consumer-grade video transmitters, and high power Amateur Radio transmitters stations. The combined interference generated by all these devices is making reliable use of these bands for long-range outdoor use untenable in many urban areas. In the near future, the numbers of locales where interference abounds will increase.

There is, however, a license-free Spread Spectrum band in the 5.725 to 5.850 GHz range available for use in the United States and other countries. However, the cost for outdoor radio devices that operate in this band can be ten to twenty times more expensive then the low-cost 2.4 GHz radio equipment. The present invention enables any 2.4 GHz TDD Spread Spectrum radio devices to operate in the 5.8 GHz band or any other radio band thereby avoiding all the interference found on the 2.4 GHz band. Further, the present invention can be utilized to convert any TDD radio on any band to operate on any other radio band.

Still further, the present invention can be utilized to enable TDD radios to operate split-band (i.e., transmitting on one band and receiving on another). By applying the principles of the present invention, the limitation of co-locating only a few 802.11b DSSS radios at any one location can be resolved. In fact, using the present invention discloses how all of the 802.11b radio channels could be utilized at any one location in a properly designed system.

### BRIEF DESCRIPTION OF DRAWINGS

FIG. 1 shows a typical installation drawing with Converter Amplifier mounted near the antenna with coax cables connecting it to the DC Injector and radio transceiver

FIG. 2 shows a simple block diagram illustrating how the Converter Amplifier module translates radio frequencies

FIG. 3 shows the circuit elements found inside the bi-directional Converter Amplifier module

FIG. 4 shows the one-way Converter Amplifier module where only the transmitted signal gets translated.

FIG. 5 shows the component to FIG. 4 where only the received signal gets translated.

FIG. 6 illustrates how complementary pair of one-way Converter Amplifiers communicate over-the-air.

FIG. 7 shows an alternate form of the Converter Amplifier where no DC Injector is required when the radio transceiver and antenna are all co-located.

FIG. 8 illustrates how a multi-channel system can be deployed using one-way frequency conversions at each end of a link.

### DESCRIPTION OF THE PREFERRED EMBODIMENTS

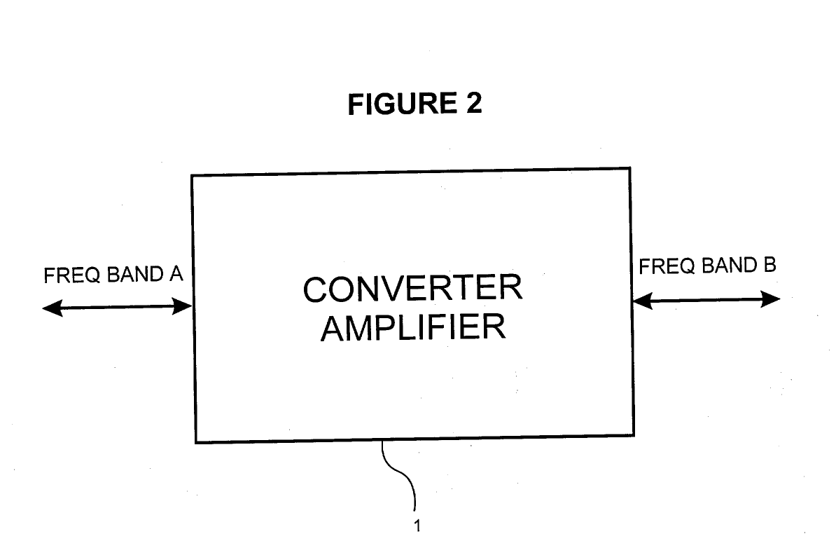

Refer to FIG. 2. In transmit mode, radio frequency (RF) signals generated in the radio device connected to Converter Amplifier 1 on frequency band A are converted to frequency band B. Likewise, when Converter Amplifier 1 is in the receive mode, received signals entering Converter Amplifier 1 in frequency band B are converted to frequency band A. Converter Amplifier 1 is a half-duplex device and automatically switches from receive to transmit mode. The device can be built to either up or down convert. In other words, the converted frequencies could be either higher or lower in frequency than the operating frequency of the radio it is connected to.

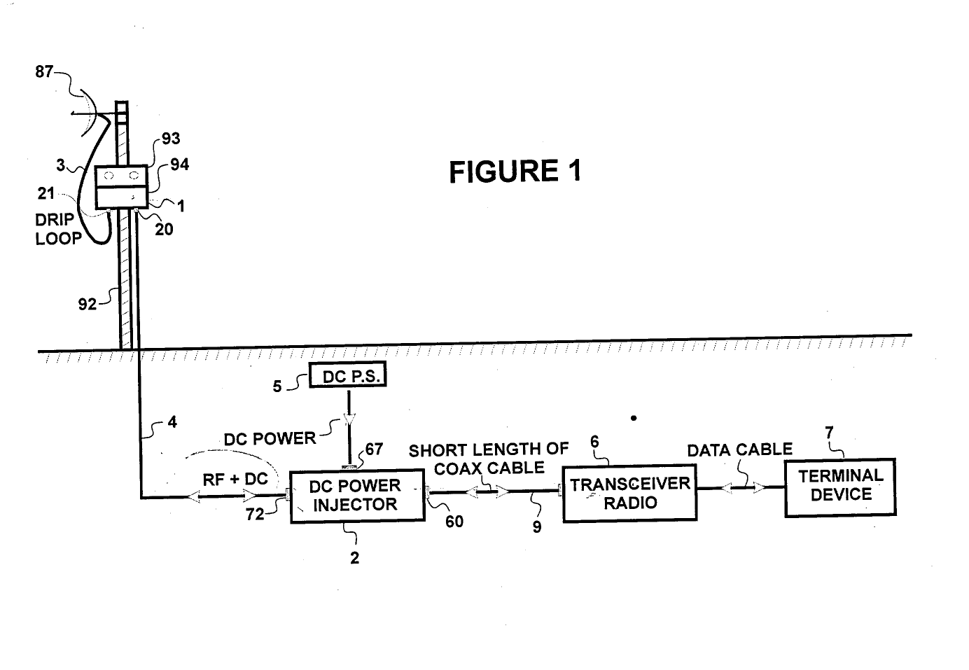

FIG. 1 details the preferred installation of the present invention. Normally, antenna connector 21 is connected via coax cable 3 external antenna 87 tuned to operate on to frequency band B. In the receive mode, RF signals picked up by antenna 87 enter Converter Amplifier 1 at antenna connector 21. They are then converted to frequency band B, amplified and feed out of Converter Amplifier 1 at radio connector 20 to DC (direct current) Power Injector 2. The converted RF signal travels down coax cable 4 to DC Power Injector 2 through RF connector 72. The signal then passes through DC Power Injector 2, out RF connector 60 and to Transceiver Radio 6 thru the second coax cable 9 attached to Transceiver Radio 6.

When Transceiver Radio 6 goes into the transmit mode, RF energy from Transceiver Radio 6 travels the same path. The signal passes from Transceiver Radio 6 through coax cable 9 in RF connector 60 to DC Power Injector 2 on through coax cable 4 to Converter Amplifier 1 through radio connector 20. They are then converted to frequency band B, amplified and fed out of Converter Amplifier 1 at antenna connector 21 to external antenna 87 via coax cable 3.

DC Power Injector 2 serves the primary purpose of injecting DC power onto coax cable 4 to power the electronics in Converter Amplifier 1. Additionally, DC Power Injector 2 offers lightning and power surge protection as well as LEDs to show the operational status of the system.

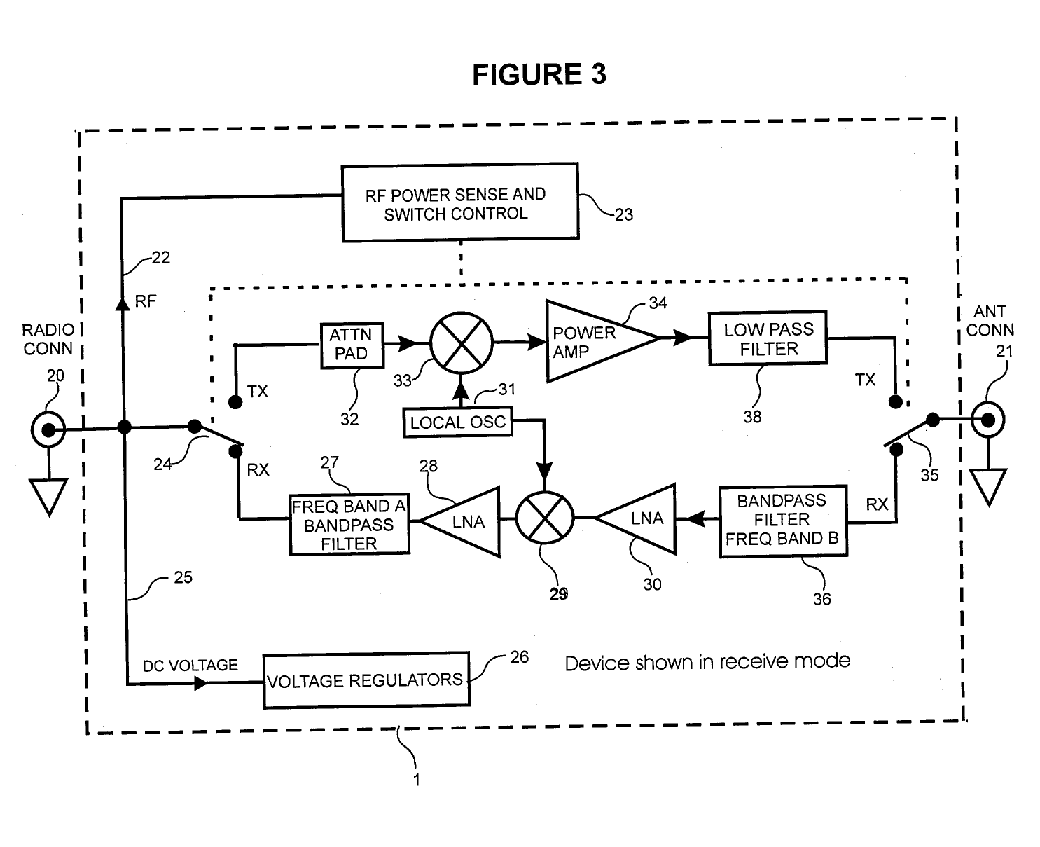

FIG. 3 shows the circuit components inside Converter Amplifier 1 in the preferred embodiment. In the receive mode, the received RF signal enters Converter Amplifier 1 at antenna connector 21. The signal is filtered by frequency band B Bandpass Filter 36 via electronic switch 35 and proceeds into noise amplifier (LNA) 30. This signal is fed into receive RF Mixer 29 where it is mixed with the signal from Local Oscillator (LO) 31. The resulting signal is converted or translated to RF frequency band A and fed though frequency band A Bandpass Filter 27 and tuned to pass all frequencies in band A. The signal is then passed through input switch 24 and to radio connector 20 where it is ultimately presented to Transceiver Radio 6 from the transmission coax cable 4, through DC Power Injector 2 and along coax cable 9.

When Transceiver Radio 6 is operated in the transmit mode, the RF energy enters Converter Amplifier 1 at the radio connector 20. The Power Sense circuitry switches the converter module from receive to transmit mode. The transmit signal in frequency band A from Transceiver Radio 6 passes through input switch 24 through attenuator pad 32. Attenuator pad 32 reduces the transmit signal to a level suitable for the input of transmit mixer 33. This signal is combined with the output of LO 31 and converted to frequency band B. It is then amplified to the desired power level by power amplifier 34. The signal then passes through output switch 35 and Frequency Band B Bandpass Filter 36 to antenna connector 21 and antenna 87 shown in FIG. 1.

The DC voltage to power Converter Amplifier 1 is picked off radio connector 20 through an inductor and fed to power supply 26 to power the circuitry in the converter module.

Alternate Forms of the Converter Module

Alternate forms of the converter module include implementations which a converter amplifier module is built to convert either the receive or transmit signals to the other band, but not both. In this case, the signal that is not translated is simply amplified and filtered. This approach enables band-slot operation where one system transmits over-the-air on frequency band A and the other on frequency band B. In this configuration, the Converter Amplifier requires two antenna connectors with each one connected to a separate external antennas. One antenna is tuned to frequency band A and the other frequency band B.

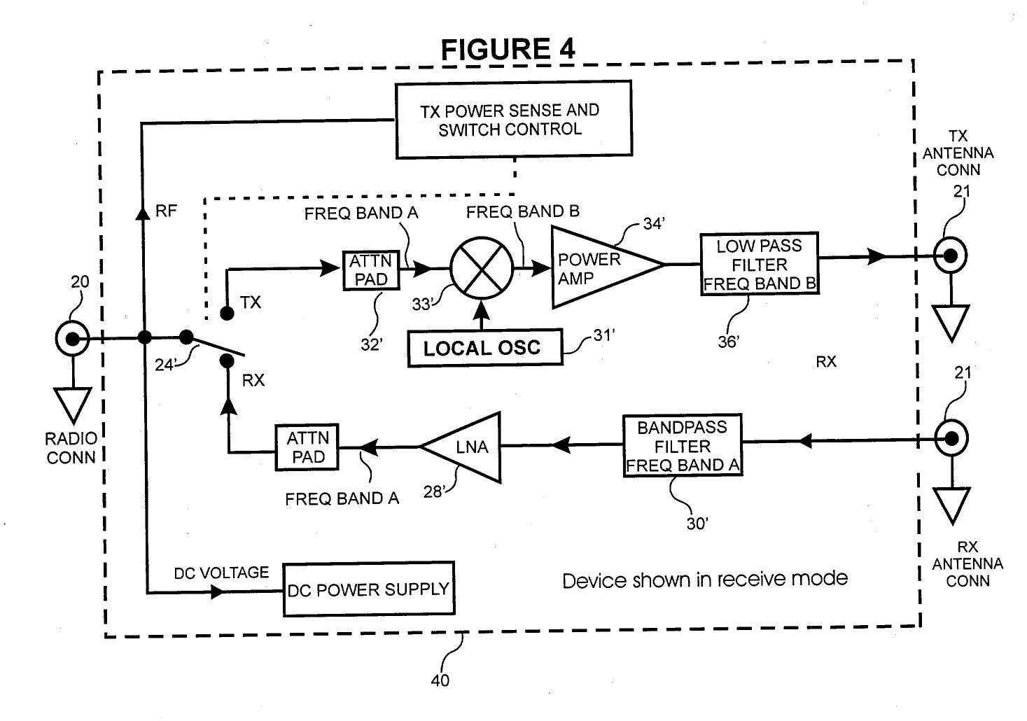

Referring to FIG. 4, a one-way Converter 40 translates the transmit signal from the radio to frequency band B through input switch 24, attenuator pad 32 and mixer 33. The signal is amplified by power amplifier 34 and passes through Bandpass Filter 36 tuned to Frequency Band B. However, in this version of Converter 40, the receive frequency is not converted, but rather it is just filtered 30, amplified 28 and sent through an optional attenuate through input switch 24 to Transceiver Radio 6.

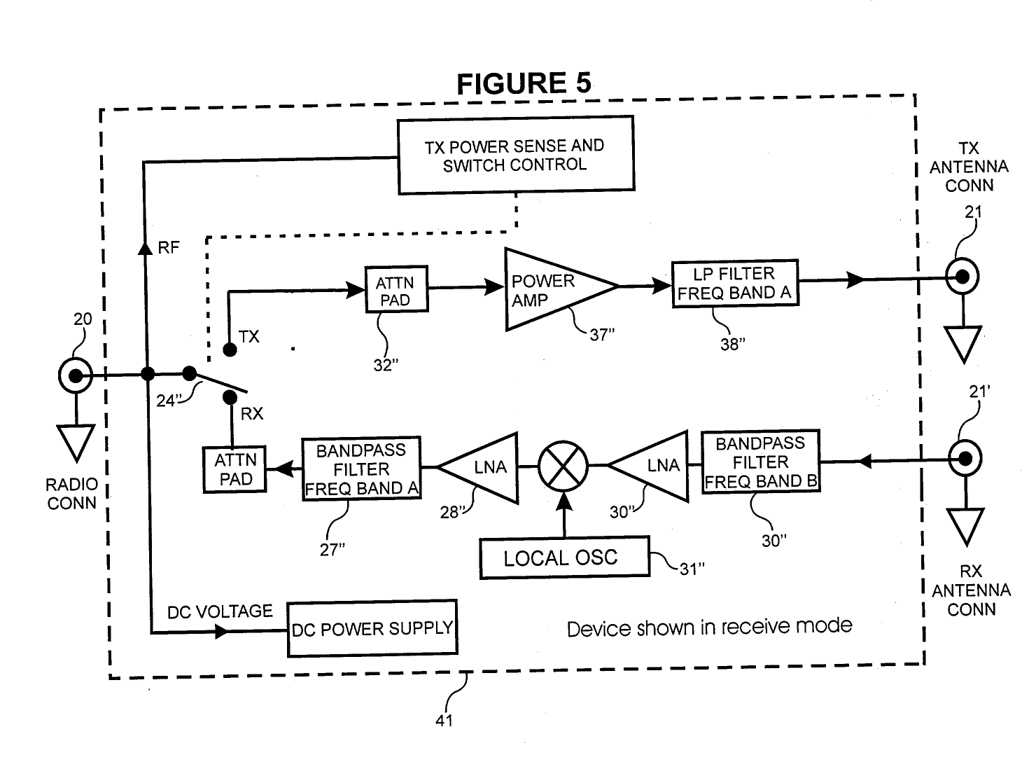

The complimentary version of this form of the converter module is shown in FIG. 5. One-way Converter 41 converts the receive signal on frequency band B entering the converter on antenna connector 21. The transmit signal from Transceiver Radio 6 on frequency band B enters Converter 41 at the radio connector 20 and is amplified 37 and filtered 38 without being converted to frequency band B.

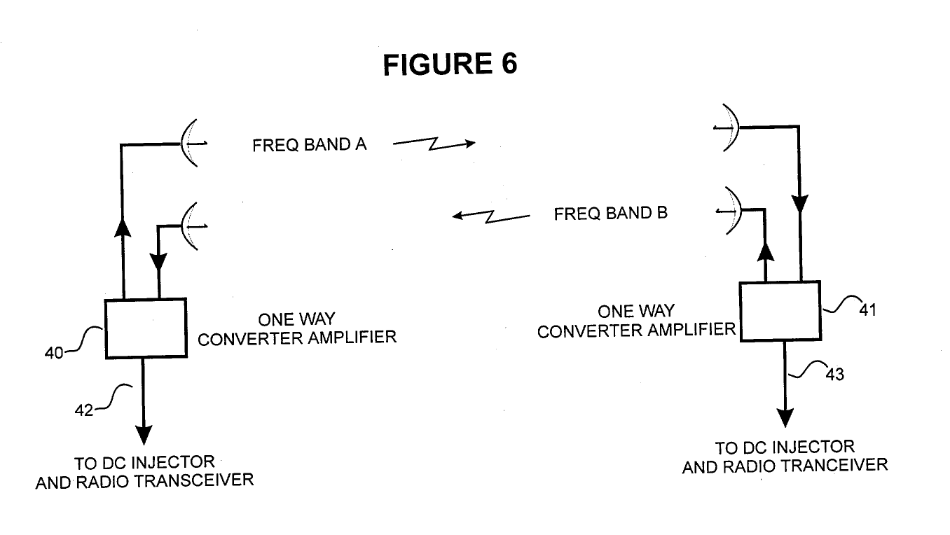

These two implementations of one-way conversion devices work as a complimentary pair to each other. FIG. 6 illustrates two one-way Converters 40, 41 in a typical link. One of the primary advantages of this arrangement is that at a base site, multiple transmitters could be all transmitting on different radio channels in frequency band and all the reception on frequency group B. This split-band operation prevents in-band signals from overloading local receivers since the receive signals are found in frequency band B not frequency band A where all the strong transmit signals are located.

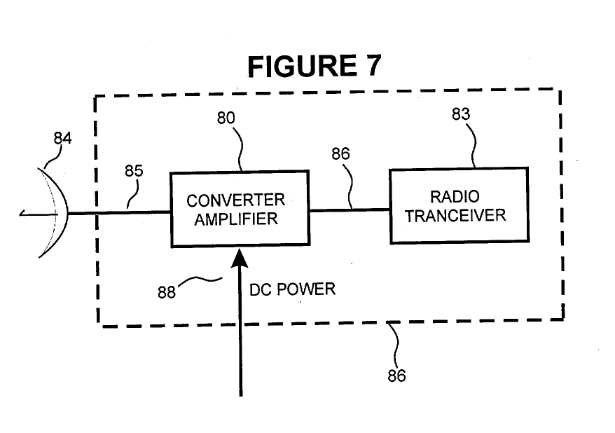

FIG. 7 illustrates an additional alternate form of the present invention where Converter Amplifier 80 has its DC Power 88 applied directly to it without the use of a DC power injector. This form could be used when Converter Amplifier 80 is located very close to radio transceiver 83. In this case, the coax cables that run from antenna 84, Converter Amplifier 80 and radio transceiver 83 are all short. Typically, Converter Amplifier 80 and radio transceiver 83 would both be located in outdoor enclosure 86. This configuration precludes the need for a DC injector.

Multi-channel Split-band System

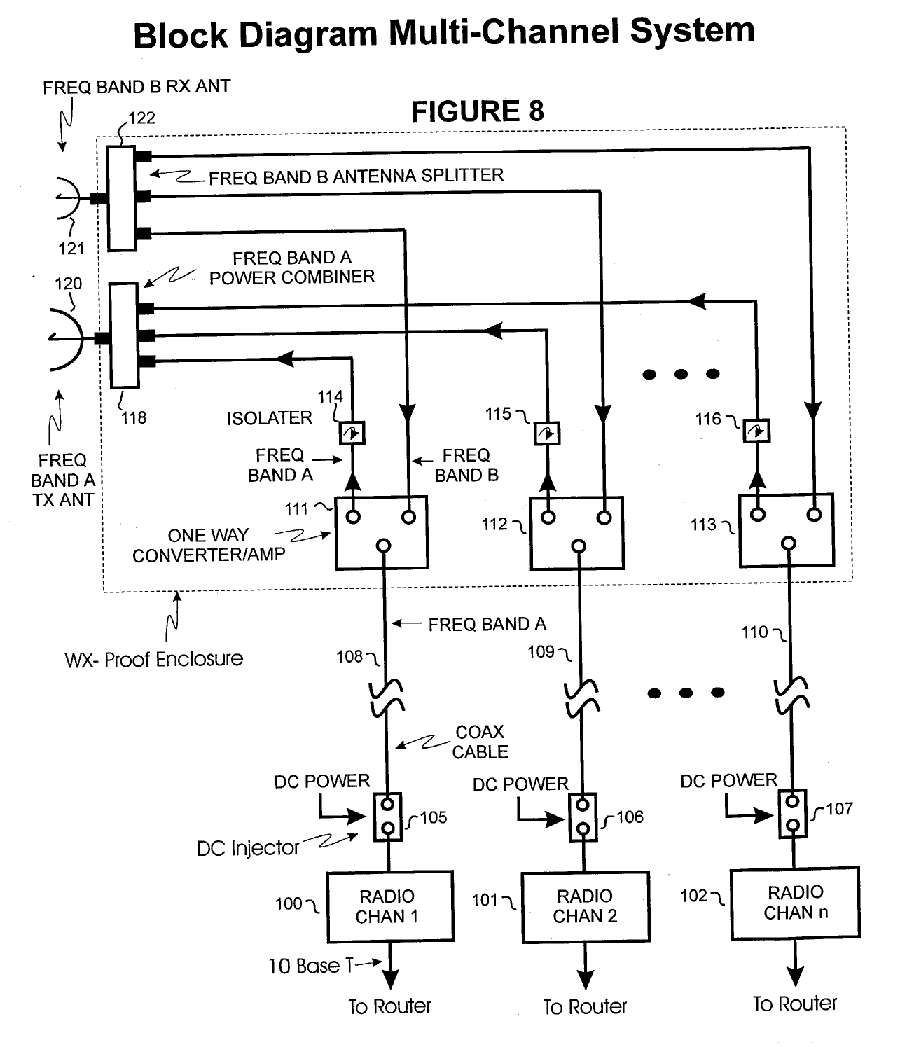

FIG. 8 illustrates one of the ways a multi-channel system can be deployed using one-way converter amplifiers. In this system, there are “n” radio transceivers 100, 101, 102 operating on frequency band A. Each radio has its own DC Injector 105, 106, 107, coax cable 108, 109, 110 and one-way Converter Amplifier 111, 112, 113. These converter amplifiers are shown in FIG. 5. They are one-way converters and, on this end of the link, only convert received signals on frequency band B down to frequency band A. The frequency band A signals coming from radio transceivers 100, 101, 102 are only amplified, not translated, in the Converter Amplifier. The transmit signals from each Converter Amplifier 111, 112, 113 (still on frequency band A) are fed through an optional RF Isolator 114, 115, 116 and fed into a transmitter combiner 118 and thence into one or more common transmit antenna 120 and sent to remote units. Signals on frequency B from the remote units are received by antenna 121, fed through splitter 122 and into Converter Amplifiers 111, 112, 113. These signals are converted to frequency band A and sent to radio transceivers 100, 101, 102.

A similar complimentary operation occurs at the remote unit. In this case, the converter amplifier in FIG. 4 is used (i.e., the radio transceivers' transmit frequencies are translated from A to B, but the received signals are not translated since they already are on frequency band A.). The over-the-air frequency used for this system is shown in FIG. 6.

What is claimed is:

1. A bi-directional two-way signal converter amplifier system having a frequency converter for connecting a radio means operating at a first frequency band to radiating means operating at a second frequency band wherein RF signals received by said radiating means on said second frequency band are converted to said first frequency band and amplified for utilization by said radio means, and transmitted signals from said radio are converted to said second frequency band, amplified and connected to said radiating means for emission.

2. The frequency converter amplifier system of claim 1 wherein automatic switching means is provided for alternately converting and amplifying radio signals on said first and second frequency bands from said radio means to said second and first frequency bands respectively for emission and reception by said radiating means.

3. The communication system of claim 2 wherein said frequency converter utilizes a time division duplex means.

4. The communication system of claim 3 wherein said converter amplifier system that has an RF power sensing means that detects transmitter RF energy from said radio means and automatically switches the converter amplifier from receive to transmit mode thereby changing the direction of the frequency conversion.

5. The communication system of claim 1 wherein said converter amplifier is connected to said radio means via a coaxial cable.

6. The communication system of claim 1 wherein said converter amplifier is connected to a DC Injector via a first coaxial cable, said DC Injector connects to said radio via a second coax cable and said DC Injector provide DC power to the converter amplifier via said first coax cable.

7. A frequency converter amplifier system of claim 1 whereby when said converter amplifier is in receive mode and connected to an external radiating means operating on a second frequency band to a radio device operating at a first frequency band, operable in receive and transmit modes, wherein in said receive mode a radio signal on said second frequency band picked up from said radiating means, passes through a switching means, a filter means and a mixer means, said mixer means being connected to oscillator means for providing a signal at a third frequency to produce an output from said mixer means of a signal operating at said first frequency band and feed through second switching means to said radio.

8. The communication system of claim 7 whereby when said converter amplifier is in transmit mode, the radio signal at said first frequency band from said radio is switched via said second switching means and passes through a transmitter converter amplifier section, said section having an attenuator means, a second mixer means that combines with the output of said oscillator means to convert the transmit signal from said radio means operating to said second frequency band, this signal then being connected to amplifier means on said second frequency band to said first switching means that connects to said external radiating means.

9. A bi-directional one-way signal converter amplifier system having a frequency converter for connecting a radio means operating at a first frequency band to a first radiating means operating at a second frequency band and to a second radiating means operating on said first frequency band, wherein RF signals on said second frequency band received by said first radiating means are converted to said first frequency band and amplified for utilization by said radio means, wherein transmitted signals from said radio means on said first frequency band are not converted to said second frequency band, but are amplified and connected to a second radiating means operating on said first frequency band for emission.

10. A bi-directional one-way signal converter amplifier system having a frequency converter for connecting a radio means operating at a first frequency band to a first radiating means operating at a second frequency band and to a second radiating means operating on said first frequency band wherein RF transmitted signals on a first frequency band from said radio are converted to a said second frequency band, amplified and connected to said second radiating means operating on a second frequency band for emission, and wherein RF signals on said first frequency band received by said radiating means not converted, but are amplified for utilization by said radio means.

11. A multi-channel split-band communication system utilizing one-way converter amplifiers comprising:
a plurality of radio transceivers operating on a first frequency band, each said plurality of radio transceivers being connected to a one-way converter,
each of said one-way converters having means to connect to a first radiating means operating on said first frequency band and a second radiating means operating on a second frequency band,
each said radio transceiver having an RF signal output in said first frequency band being amplified by said one-way converters and fed to said antenna means operating on said first frequency band, and
each said radio transceiver also having an RF input signal in said first frequency band that was converted from said second frequency band by said one-way converters connected to said second radiating means operating on a second frequency band.
